(19) United States
(12) Patent Application Publication
(10) Pub. No.: US 2025/0237789 A1
(43) Pub. Date: Jul. 24, 2025

(54) ANTIREFLECTIVE COATING AND USES THEREOF

(71) Applicant: Ramot at Tel-Aviv University Ltd., Tel-Aviv (IL)

(72) Inventor: Jacob SCHEUER, Tel Aviv (IL)

(73) Assignee: Ramot at Tel-Aviv University Ltd., Tel-Aviv (IL)

(21) Appl. No.: 18/701,978

(22) PCT Filed: Oct. 28, 2022
(86) PCT No.: PCT/IL2022/051145

§ 371 Date: Apr. 17, 2024

Related U.S. Application Data
(60) Provisional application No. 63/272,792, filed on Oct. 28, 2021.

(51) Int. Cl. G02B 1/11

(52) U.S. Cl. CPC G02B 1/11

(57) ABSTRACT

An antireflective coating for reducing reflection of a wave off the coating, comprises a stack of layers, each having a discrete array of resonators characterized by a resonant wavelength within a spectral band of the wave, wherein at least two layers are characterized by different resonant wavelengths such that a set of resonant wavelengths of all layers discretely spans over the spectral band.

### RELATED APPLICATION

This application claims the benefit of priority of U.S. Provisional Patent Application No. 63/272,792 filed on Oct. 28, 2021, the contents of which are incorporated herein by reference in their entirety.

### FIELD OF THE INVENTION

The present invention, in some embodiments thereof, relates to controlling wave phenomena and, more particularly, but not exclusively, to an antireflective coating and uses thereof.

### BACKGROUND OF THE INVENTION

U.S. Published application No. 20070159698 discloses an antireflective member that has an uneven surface pattern, in which unit structures are arranged on the surface of a substrate in x and y directions at respective periods that are both shorter than the shortest wavelength of an incoming light ray. Disclosed are periods which are less than half and less than two-fifths of the shortest wavelength.

International publication No. WO2015079051 discloses nano-patterned antireflection coating which includes an array of nanoparticles and/or nanoholes, wherein the geometrical filling fraction of the nanoparticles and/or nanoholes approximately matches the optimal filling fraction of a system that includes a substrate coated by the antireflection coating.

Additional background art includes Chattopadhyay et al., Materials Science and Engineering R 69 (2010) 1-35; Eric et al., J. Opt. Soc. Am. A 12(2), 333-339 (1995); Lalanney et al., Nanotechnology 8 (1997) 53-56; Hitoshi Sai et al., Applied Physics Letters 88, 201116 (2006); Southwell, J. Opt. Soc. Am. A 8(3),549-553 (1991); Motamedi et al., Applied Optics 31(22), 4371-4376 (1992); Daniel et al., Applied Optics 32(7), 1154-1167 (1993); and Spinelli et al., Nature Communications 3:692 (2012).

### SUMMARY OF THE INVENTION

According to an aspect of some embodiments of the present invention there is provided an antireflective coating for reducing reflection of a wave off the coating. The antireflective coating being designed and constructed for a wave having a plurality of wavelength spanning over a specific spectral band. The wave can be an electromagnetic wave, in which case the spectral band can be an RF spectral band, a millimeter waves spectral band, a THz spectral band, or an optical spectral band. The wave can alternatively be a mechanical wave, such as, but not limited to, an acoustic wave or other forms of a pressure wave.

The antireflective coating comprises a stack of layers, each having a discrete array of resonators characterized by a resonant wavelength within the spectral band of the wave, wherein at least two layers are characterized by different resonant wavelengths such that a set of resonant wavelengths of all layers discretely spans over the spectral band of the wave.

The size of each resonator is less than the respective resonant wavelength. Preferably, the size of each resonator is less than the respective resonant wavelength but more than half the respective resonant wavelength, more preferably more than 60% of the respective resonant wavelength, more preferably more than 70% of the respective resonant wavelength, more preferably more than 80% of the respective resonant wavelength, more preferably more than 90% of the respective resonant wavelength.

The resonators in different layers can have the same or different shape.

According to some embodiments of the invention the coating is formed on a substrate, wherein a material of the coating is identical to a material of the substrate.

According to some embodiments of the invention, for at least one layer, more preferably for more than one layer, e.g., for each of the layers in the stack, at least two adjacent resonators of said layer are spaced apart from each other.

According to some embodiments of the invention, a material of the substrate is transparent to a wave at a range of wavelengths, wherein a periodicity of the resonators is less than 2 min/n, where λₘᵢₙ is a shortest wavelength of the range of wavelengths and n is a refractive index of the substrate coated by the coating.

According to some embodiments of the invention, a material of the substrate is transparent to a wave at a range of wavelengths, wherein at least two layers have different periodicity among the resonators therein, and wherein the periodicity in the ith layer is less than λ_{i,min}/n, where λ_{i,min} is a shortest wavelength of a range of resonant wavelengths corresponding to the ith layer, and n is a refractive index of the substrate coated by the coating.

According to some embodiments of the invention coating is devoid of resonators characterized by a resonant wavelength below a lower bound of the spectral band.

According to some embodiments of the invention the resonators comprise at least one resonator having a base and at least one wall perpendicular to the base. According to some embodiments of the invention the resonators comprise a plurality of resonators, each having a base and at least one wall perpendicular to the base. According to some embodiments of the invention at least one layer comprises a plurality of resonators, each having at least one wall perpendicular to the layer.

According to some embodiments of the invention the resonators comprise at least one resonator having at least one rectangular wall. According to some embodiments of the invention the resonators comprise at least one resonator having two or more rectangular walls.

Also contemplated are resonator bases and/or walls having other shapes, such as, but not limited to, circular, elliptic, triangular, hexagonal, polygonal profile.

According to an aspect of some embodiments of the present invention there is provided a method, comprising directing a wave to the coating according as delineated above and optionally and preferably as further detailed below.

According to an aspect of some embodiments of the present invention there is provided an optical element, comprising a substrate and the coating as delineated above and optionally and preferably as further detailed below.

According to an aspect of some embodiments of the present invention there is provided a display device, comprising the optical element. According to some embodiments of the invention the display device is a display device of a mobile device selected from the group consisting of a smartphone, a tablet, a smartwatch, and an electronic book reader device, such as, but not limited to, a kindle.

According to an aspect of some embodiments of the present invention there is provided a lens device, comprising the optical element.

According to an aspect of some embodiments of the present invention there is provided a diffraction grating, comprising the optical element.

According to an aspect of some embodiments of the present invention there is provided an optical coupler, comprising the optical element.

According to an aspect of some embodiments of the present invention there is provided an imager, comprising the optical element. According to some embodiments of the invention the coating is positioned to reduce crosstalks among pixels of the imager.

According to an aspect of some embodiments of the present invention there is provided an image projector system, comprising the optical element.

According to an aspect of some embodiments of the present invention there is provided a windshield, comprising the optical element.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an antireflective coating for reducing reflection of a wave off the coating, according to some embodiments of the present invention;

FIG. 2 shows a calculated spectral reflectance, obtained according to some embodiments of the present invention; and

FIG. 3 shows calculated reflection spectra as a function of the periodicity, obtained according to some embodiments of the present invention.

### DESCRIPTION OF SPECIFIC EMBODIMENTS OF THE INVENTION

The present invention, in some embodiments thereof, relates to controlling wave phenomena and, more particularly, but not exclusively, to an antireflective coating and uses thereof.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

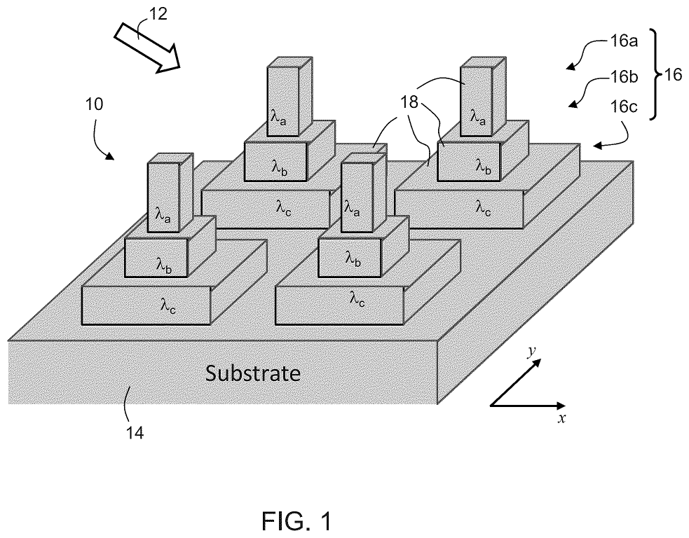

Referring now to the drawings, FIG. 1 is a schematic illustration of an antireflective coating 10 for reducing reflection of a wave 12 off coating 10, according to some embodiments of the present invention. Coating 10 coats a substrate 14, which can be a substrate of any object for which it is desired to reduce reflection of a wave 12. For example, substrate 14 can be a substrate of an optical element. One such optical element is a screen of a display device. The display device can in some embodiments of the present invention be a display device of a mobile device, such as, but 15 not limited to, a smartphone, a tablet, a smartwatch, and an electronic book reader device, e.g., a Kindle®.

Other optical elements which can include a substrate coated by coating 10 including, without limitation, a lens device, windshield a diffraction grating, an optical coupler, an image projector system, and an imager. When the substrate coated by coating 10 is a substrate of an imager, the substrate can be a pixelated sensor array of the imager, and coating 10 is preferably positioned on the sensor array to reduce cross-talks among the pixels of the array.

Antireflective coating 10 is designed for a specific type of wave and a specific spectral band of the wave 12. Thus, wave 12 can be an electromagnetic wave, or a mechanical wave, such as, but not limited to, a pressure wave, e.g., an acoustic wave. The spectral band of wave 12 is denoted herein [λₘᵢₙ, λₘₐₓ], and antireflective coating 10 is designed to reduce reflection for any component of wave 12 having a wavelength λ satisfying λ∈[λₘᵢₙ, λₘₐₓ].

When wave 12 is an electromagnetic wave, the spectral band can be, for example, an RF spectral band, a millimeter waves spectral band, a THz spectral band, or an optical spectral band. The can be one of these spectral bands in its entirety (e.g., the entire RF spectral band, or the entire millimeter waves spectral band, or the entire THz spectral band, or the entire optical spectral band), or, more preferably it can be a sub-band thereof. Also contemplated, are embodiments in which the lower limit 2 min of the spectral band is in one of these spectral bands and the upper limit λₘₐₓ of the spectral band is in another one of these spectral bands.

Antireflective coating 10 comprises a stack 16 of layers 16a, 16b, 16c (three shown in the illustrated embodiments, but any number of layers can be employed). Preferably, each of the layers in stack 16 is made of a metamaterial in the form of a discrete array of resonators 18 characterized by a resonant wavelength within the spectral band [λₘᵢₙ, λₘₐₓ]. Thus, for example, the resonators 18 of layer 16a can be characterized by a resonant wavelength λₐ, the resonators 18 of layer 16b can be characterized by a resonant wavelength λ_{b}, and the resonators 18 of layer 1ca can be characterized by a resonant wavelength λ_{c}. At least two adjacent resonators at each layer are optionally and preferably spaced apart from each other.

While FIG. 1 illustrates resonators arranged in a rectangular array, this need not necessarily be the case, since, for some applications, it may be desired to employ other arrangements, such as, but not limited to, hexagonal array, quasi-crystal shape, or randomly.

At least two of layers 16a, 16b, and 16c are characterized by different resonant wavelengths so that the values of at least two of λₐ, λ_{b}, and λ_{c} are different from each other. The resonant wavelength of each resonator can be set by selecting appropriate dimension to the resonator. For example, when the resonator is shaped as a rectangular box, its resonant wavelength can be set by a judicious selection of the width, length and thickness (height) of the box. In the illustrated embodiment, which is not to be considered as limiting, the resonators 18 of layer 16c are larger in size than the resonators 18 of layer 16b, and the resonators 18 of layer 16b are larger in size than the resonators 18 of layer 16c, so that λ_{c}>λ_{b}>λₐ.

The values of the resonant wavelengths of the individual layers are preferably selected such that the set {λₐ, λ_{b}, λ_{c}, . . . } discretely spans over the spectral band [λₘᵢₙ, λₘₐₓ]. For example, the values of the resonant wavelengths of the individual layers can be selected such that λₘᵢₙ≤λₐ<λ_{b}<λ_{c}≤λₘₐₓ. In some embodiments of the present invention coating 10 is devoid of resonators whose resonant wavelength is below λₘᵢₙ.

The number of layers in stack 16 affect the extent at which the reflection is suppressed over the spectral band, particularly when each layer is characterized by a different resonant wavelength. This is because a larger number of layers endures that the discrete span of the set {λₐ, λ_{b}, λ_{c}, . . . } more accurately resembles the continuous spectral band. The number of layers in stack 16 optionally and preferably selected based on the level of reflection suppression that coating 10 is expected to achieve.

The resonators 18 can have any shape. In the schematic illustration of FIG. 1, resonators 18 are shaped as rectangular boxes, but it is to be understood that other shapes, such as, but not limited to, other parallelograms or cylinders or the like, are also contemplated. Preferably, one or two or more of the walls of the resonators are rectangular. Also preferably, the bases of the resonators are polygon-shaped. At least one, more preferably each, of the resonators has a base and at least one wall that is perpendicular to the base.

The judicious selection of the resonant wavelengths λa, λb etc., the coating 10 exhibits resonances that generate destructive interference in reflection and constructive interference in transmission. Consequently, these resonances at least partially cancel the reflection at a plurality of specific wavelengths, each being the resonant wavelength of the resonators in a different layer of coating 10. The overall number of resonances for which there is at least a partial cancelation of the reflection is optionally and preferably equal to the number of layers in coating 10.

Coating 10 is preferably applied to a substrate (e.g., substrate 14) that is transparent to a wave at a range of wavelengths.

Herein “transparent” means transparency of at least 80% or at least 90%.

For example, substrate 14 can be transparent to all wavelengths in the spectral band [λₘᵢₙ, λₘₐₓ] fore which coating 10 is designed. When wave 12 interacts with the resonators 18 of coating 10, it experiences interferences, that are, as stated, destructive in reflection and constructive in transmission. Thus, most of the energy of wave 12 (e.g., at least 60% or at least 70% or at least 80% or at least 90%) is transmitted though coating 10 into substrate 14. When substrate 14 is transparent to wave 12, most of the energy of wave 12 is transmitted also though substrate 14.

The material from which the resonators 18 are made can be the same as the material of the substrate 14 that is coated by coating 10. Alternatively, the material from which the resonators 18 are made can different than the material of substrate 14. A material suitable for resonators 18 can be any material that is transparent in the spectral band, such as, but not limited to, Silicon, Silica, Sapphire, Quartz, SiN, TiN, GaAs, Ge, InP, InGaAs, InGaAsP, GaN, Sol-Gel, transparent curable epoxy, a transparent resist, e.g., PMMA, SU8, ZEP, and the like.

The inventor found that the periodicity of the discrete array of resonators 18 can be tailored to further reduce the reflection of coating 10.

The periodicity along a direction is the distance between the centers of nearest neighbor resonators, in case in which the resonators are equi-spaced along that direction. The periodicity along different directions (e.g., along directions x and y, see FIG. 1) over the array of resonators of a particular layer may differ. Alternatively, for a particular layer, more preferably for each layer of stack 16, the periodicity along two orthogonal directions (e.g., along directions x and y) over the array of resonators of this layer can be the same.

In some embodiments of the present invention the periodicity along any direction over the array of resonators 18 is less than λₘᵢₙ/n, where n is the refractive index of the material from which substrate 14 is made. Preferably, the periodicity is less than λₘᵢₙ/n but more than 0.8·λₘᵢₙ/n.

In some embodiments of the present invention at least two or two different sets of layers of coating 10 have different periodicities among the resonators therein. For example, the resonators in layer 16c may have a first periodicity along direction x, the resonators in layer 16b may have a second periodicity along direction x, and the resonators in layer 16a may have a third periodicity along direction x, where at least two of the first, second, and third periodicities differ. In some embodiments of the present invention the periodicity in the ith layer is less than λ_{i,min}/n, where λ_{i,min} is the shortest wavelength of a range of resonant wavelengths corresponding to the ith layer or set of layers.

The dimensions of the resonators in a particular sub-band of the spectral band, for example, in a sub-band that corresponds to the resonant wavelength of a particular layer of the stack, or a particular set of layers of the stack, can be sleeted by an optimization process. The optimization process can target a criterion that corresponds to the reflectivity over the sub-band. For example, the criterion can be that the reflectivity over the sub-band does not exceed a predetermined threshold, or that the average reflectivity over the sub-band is minimal, or that the integrated reflectivity is minimal over the sub-band, or any other cost function that depends on the reflectivity. Within the sub-band, the reflectivity need not be constant, and may exhibit one or more extremum points.

In some embodiments of the present invention the optimization process is applied to the dimensions of the resonators in a particular layer or a particular set of layers together with the respective periodicity, preferably subjected to the above condition that the periodicity is less than λ_{i,min}/n. In these embodiments, the periodicity and the dimensions are not optimized independently. Alternatively, the optimization process can be applied to the periodicity, and then separately to the dimensions of the resonators using the optimized periodicity as an input to the optimization process. Still alternatively, the optimization process can be applied to the dimensions of the resonators, and then separately to the periodicity using the optimized dimensions of the resonators as an input to the optimization process.

The discrete arrays of resonators can be provided in more than one way.

In some embodiments of the present invention, a top-down process is employed for providing the resonators. The top-down process can be a chemical process (e.g. wet etch), a physical process (e.g., inductively coupled plasma, reactive ion etching, and/or focused ion beam milling, etc.), or an optical process (e.g. ablation, two-photon polymerization, etc.). In some embodiments of the present invention, the discrete nanoparticles are formed by a bottom-up process, wherein the resonators 18 are grown on substrate 14, or on another substrate and are thereafter transferred to substrate 14. This can be done by means of 3D-printing, Nano-imprinting lithography, nano-transfer technique, etc.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

This Example describes an antireflective coating based on layers of metamaterials in the form sub-wavelength resonant structures, organized in an array, for suppressing reflection over a broad range of wavelength. A schematic of antireflective coating is depicted in FIG. 1.

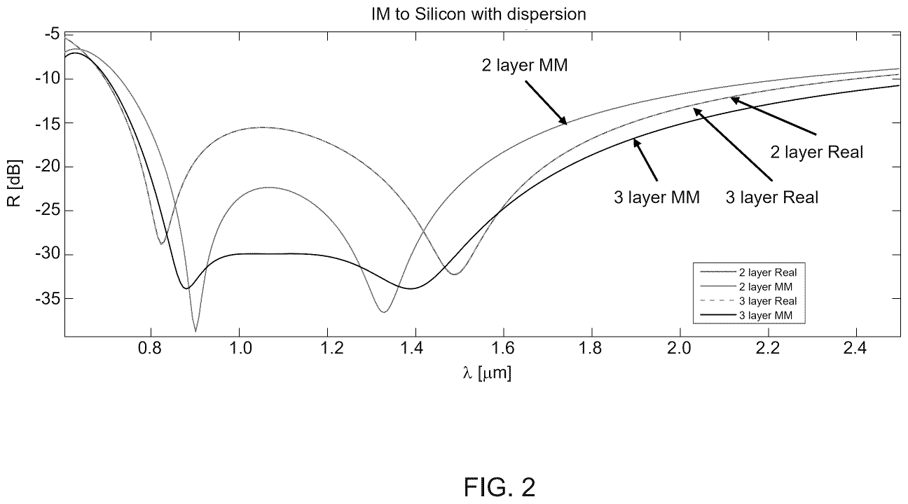

FIG. 2 shows calculated spectral reflectance from a silicon substrate which was treated for suppressed reflection to ensure impedance matching (IM) using the technique of the present embodiments. The calculation was for the case in which the coating 10 is made of the same material as the substrate (silicon, in the present Example). The coating 10 was designed to reduce reflectance in the spectral band [λₘᵢₙ, λₘₐₓ]=[0.8 μm, 1.5 μm].

Also shown, are calculated spectral reflectance from a layered structure without resonators. For both coating 10 and the layered structure without resonators, the spectral reflectance were calculated for the case of two layers and for the case of three layers.

The calculated spectral reflectance for the case in which the substrate is coated by a two-layer coating and a three-later coating of the present embodiments are denoted 2 layer MM (shown in red), and 3 layer MM (shown in black), respectively. The calculated spectral reflectance for the case in which the substrate was coated by a two-layer structure and a three-later structure without resonators are denoted 2 layer Real (shown in cyan), and 3 layer Real (shown in dotted green), respectively.

As shown, the cases in which the coating did not include resonators (2 layer Real and 3 layer Real) provided a reflectivity of less than −16 dB (about 2.5%) in the desired range. In distinction, using the technique of the present embodiments yielded a substantially lower reflectivity of less than −23 dB (about 0.5%) for two layers and less than −30 dB (about 0.1%) for three layers across the desisted spectral band.

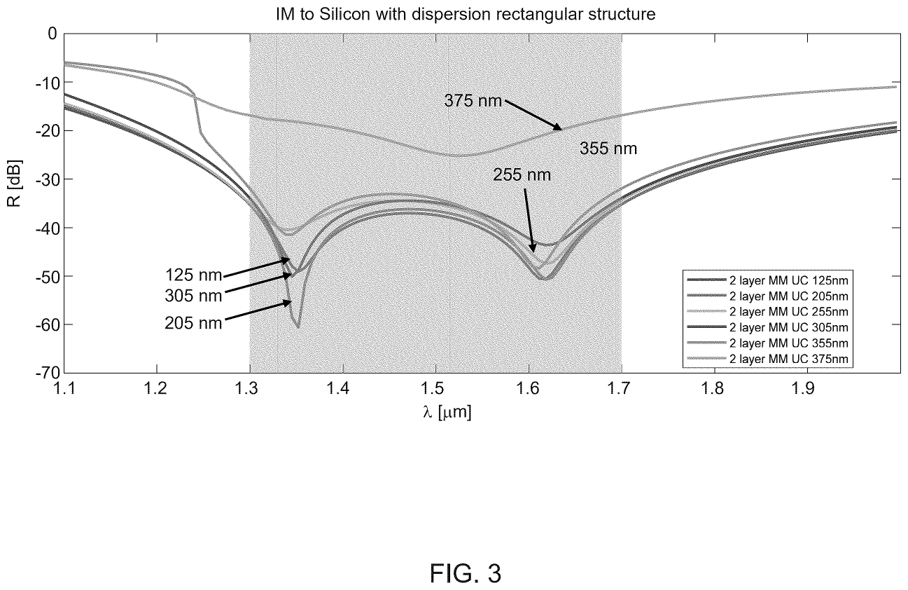

FIG. 3 shows the calculated spectral reflectance as a function of the periodicity of the resonators. The calculation was for the case in which the coating 10 is made of the same material as the substrate (silicon, in the present Example), the spectral band for which reflection suppression was desired was [λₘᵢₙ, λₘₐₓ]=[1.3 μm, 1.7 μm], and the coating 10 included two layers.

Shown in FIG. 3 are calculations for periodicity of 125 nm, 205 nm, 255 nm, 305 nm, 355 nm, and 375 nm. The refractive index n of silicon is about 3.4, and so the periodicity is preferably less than λₘᵢₙ/n=1300/3.4≈382 nm.

FIG. 3 demonstrates reflection of less than-33 dB over the desired spectral band even if the periodicity is 355 nm (corresponding to slightly less than 382 nm, the minimal wavelength in the material). For periodicity that is closer to 382 nm and beyond, there is a substantial reduction in the ability of coating 10 to reduce the reflectivity of the substrate. For example, periodicity of 375 nm, a reflection of about-16 dB was calculated.

This Example demonstrated high quality antireflection performances over a wide bandwidth, with performances that are superior to those of conventional methods.

Conventional approaches for broadband antireflection utilize either multiple layers of various materials or deep sub-wavelength conical/pyramid-shaped nano-structures (similar to the Moth-eye structure). The drawbacks of these approaches are the following:

Multiple layers of different materials: this approach is limited to the properties of existing materials. As the refractive index values of available and transparent materials are limited, the attainable of AR capability of this approach is also limited (see e.g. FIG. 2). Consequently, obtaining good AR over broad wavelengths range is often impossible and necessitates many layers and complicated optimization procedure.

Moth-eye structure (conical/pyramid-shaped nano-structures): This approach requires deep sub-wavelength periodicity/density of the nano-structures. In addition, the reflection suppression is highly sensitive to specific shape of the cones/pyramids, a property which is extremely difficult to control and to obtain in repetitive manner. Consequently, this approach is less appropriate for mass production.

The technique of the present embodiments overcome the two main drawbacks of the conventional approaches. The use of the metamaterial layers yields substantial improvement of reflection suppression (compared to the multiple material approach), particularly for broadband applications. In addition, the technique of the present embodiments can be implemented using a single material because the electromagnetic properties are controlled by the geometry. Compared to the moth-eye structure, the technique of the present embodiments does not require deep sub-wavelength features and requires the use of regular geometrical shapes (e.g. with walls forming right angle with the bases), thus facilitating simpler and repeatable fabrication which is appropriate for mass production. Furthermore, because of geometry to control the electromagnetic properties, the approach is wavelength scalable and can be used at any frequency band (RF, mm-waves, THz, optical frequencies) and can also be used for applications beyond optics and electromagnetic waves such as acoustics, pressure waves, etc.

Due to the above, the technique of the present embodiments provides a viable solution to the problem of broadband high quality AR functionality, beyond the capability of conventional approaches.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. An antireflective coating for reducing reflection of a wave off the coating, the wave having a spectral band, comprising a stack of layers, each having a discrete array of resonators characterized by a resonant wavelength within the spectral band, wherein at least two layers are characterized by different resonant wavelengths such that a set of resonant wavelengths of all layers discretely spans over the spectral band.

2. The coating of claim 1, being formed on a substrate, wherein a material of said coating is identical to a material of said substrate.

3. The coating according to claim 1, wherein at least two adjacent resonators at each layer are spaced apart from each other.

4. The coating according to any of claims 1-3, being formed on a substrate, wherein a material of said substrate is transparent to a wave at a range of wavelengths, and wherein a periodicity of said array of resonators is less than a shortest wavelength of said range of wavelengths divided by a refractive index of said material.

5. The coating according to any of claims 2-4, being formed on a substrate, wherein a material of said substrate is transparent to a wave at a range of wavelengths, and wherein a periodicity of said array of resonators is less than a shortest wavelength of said range of wavelengths divided by a refractive index of said material.

6. The coating according to claim 4, wherein said periodicity is more than 80% of said shortest wavelength of said range of wavelengths divided by said refractive index of said material.

7. The coating according to claim 5, wherein said periodicity is more than 80% of said shortest wavelength of said range of wavelengths divided by said refractive index of said material.

8. The coating according to claim 1, being devoid of resonators characterized by a resonant wavelength below a shortest wavelength of the spectral band.

9. The coating according to any of claims 2-7, being devoid of resonators characterized by a resonant wavelength below a shortest wavelength of the spectral band.

10. The coating according to claim 1, wherein said resonators comprise at least one resonator having a base and at least one wall perpendicular to said base.

11. The coating according to any of claims 2-9, wherein said resonators comprise at least one resonator having a base and at least one wall perpendicular to said base.

12. The coating according to claim 1, wherein said resonators comprise at least one resonator having at least one rectangular wall.

13. The coating according to any of claims 2-11, wherein said resonators comprise at least one resonator having at least one rectangular wall.

14. The coating according to claim 1, wherein said resonators comprise at least one resonator having two or more rectangular walls.

15. The coating according to any of claims 2-11, wherein said resonators comprise at least one resonator having two or more rectangular walls.

16. The coating according to claim 1, wherein said resonators comprise a plurality of resonators, each having a base and at least one wall perpendicular to said base.

17. The coating according to any of claims 2-15, wherein said resonators comprise a plurality of resonators, each having a base and at least one wall perpendicular to said base.

18. The coating according to claim 1, wherein at least one layer comprises a plurality of resonators, each having at least one wall perpendicular to said layer.

19. The coating according to any of claims 2-17, wherein at least one layer comprises a plurality of resonators, each having at least one wall perpendicular to said layer.

20. A method of transmitting a wave, comprising directing the wave to the coating according to claim 1.

21. A method of transmitting a wave, comprising directing the wave to the coating according to any of claims 2-19.

22. An optical element, comprising a substrate and the coating according to claim 1 formed thereon, wherein the spectral band is an electromagnetic spectral band.

23. An optical element, comprising a substrate and the coating according to any of claims 2-19 formed thereon, wherein the spectral band is an electromagnetic spectral band.

24. A display device, comprising the optical element according to claim 22.

25. A display device, comprising the optical element according to claim 23.

26. The display device according to claim 24, being a display device of a mobile device selected from the group consisting of a smartphone, a tablet, a smartwatch, and an electronic book reader device, such as, but not limited to, a kindle.

27. The display device according to claim 25, being a display device of a mobile device selected from the group consisting of a smartphone, a tablet, a smartwatch, and an electronic book reader device, such as, but not limited to, a kindle.

28. A lens device, comprising the optical element according to claim 22.

29. A diffraction grating, comprising the optical element according to claim 22.

30. An optical coupler, comprising the optical element according to claim 22.

31. An imager, comprising the optical element according to claim 22.

32. An imager, comprising the optical element according to claim 23.

33. The imager according to claim 31, wherein said coating is positioned to reduce crosstalks among pixels of the imager.

34. The imager according to claim 32, wherein said coating is positioned to reduce crosstalks among pixels of the imager.

35. An image projector system, comprising the optical element according to claim 22.

36. A windshield, comprising the optical element according to claim 22.

37. An optical device, comprising the optical element according to claim 23, wherein said optical device is selected from the group consisting of a lens device, a diffraction grating, an optical coupler, an image projector system, and windshield.
